(19) United States
(12) Patent Application Publication
(10) Pub. No.: US 2021/0071970 A1
(43) Pub. Date: Mar. 11, 2021

(54) ALUMINUM ALLOY HEAT EXCHANGER FOR EXHAUST GAS RECIRCULATION SYSTEM

(71) Applicants: UACJ Corporation, Tokyo (JP); DENSO CORPORATION, Kariya-shi, Aichi (JP)

(72) Inventors: Yoshiyuki Oya, Tokyo (JP); Tomohiro Shoji, Tokyo (JP); Atsushi Fukumoto, Tokyo (JP); Kouki Nishiyama, Kariya-shi (JP); Toru Ikeda, Kariya-shi (JP); Takahiro Shinoda, Kariya-shi (JP)

(73) Assignees: UACJ Corporation, Tokyo (JP); DENSO CORPORATION, Kariya-shi, Aichi (JP)

(21) Appl. No.: 17/042,358

(22) PCT Filed: Mar. 27, 2019
(86) PCT No.: PCT/JP2019/013299

§ 371 Date: Sep. 28, 2020

(30) Foreign Application Priority Data
Mar. 29, 2018 (JP) 2018-063774

(51) Int. Cl. F28F 21/08; C22C 21/14; C22C 21/16; C22C 21/10; C22C 21/02

(52) U.S. Cl. CPC F28F 21/08; C22C 21/14; C22C 21/02; C22C 21/10; C22C 21/16

(57) ABSTRACT

An aluminum alloy heat exchanger for an exhaust gas recirculation system, obtained by brazing: a tube material comprising at least a core material made of aluminum alloy comprising 0.10 to 1.50% of Si, 0.05 to 3.00% of Cu, and 0.40 to 2.00% of Mn, and a sacrificial anticorrosion material made of aluminum alloy comprising 2.00 to 6.00% of Zn, with a Si content of less than 0.10%, clad on the inner side surface of the core material; and a fin material comprising a core material made of aluminum alloy comprising 0.10 to 1.50% of Si, and 0.40 to 2.00% of Mn, with a Zn content of less than 0.05%, and a brazing material clad on both surfaces of the core material, made of aluminum alloy comprising 3.00 to 13.00% of Si, with a Zn content of less than 0.05%.

### TECHNICAL FIELD

The present invention relates to, in an exhaust gas recirculation system for recirculating the exhaust gas of an internal combustion engine mounted on a vehicle, an aluminum alloy heat exchanger for the exhaust gas recirculation system to cool the exhaust gas by heat exchange.

### BACKGROUND ART

An aluminum (Al) alloy is lightweight and has excellent thermal conductivity, capable of achieving high corrosion resistance by an appropriate processing and efficient joining by brazing using a brazing sheet, having been widely used as material for a heat exchanger.

In recent years, an exhaust gas recirculation device (EGR system) has been introduced to achieve improvement in performance of automobiles or environmental friendliness, with part of the combustion gas (exhaust gas) of an engine being introduced to the intake side to be mixed with an intake gas for improvement in fuel efficiency and reduction in discharge of NOx with decrease in combustion temperature.

The EGR system incorporates an EGR cooler to increase the gas density with decrease in the temperature of the hot exhaust gas for reduction of loss in an engine and prevention of knocking. The material of the EGR cooler needs to have high-temperature resistant strength for circulation of high-temperature combustion gas, and corrosion resistance to strongly acidic condensed water formed when cooling the combustion gas comprising a high concentration of hydrochloric acid, nitric acid, sulfuric acid, etc. produced by combustion. A stainless steel is, therefore, mainly used as the material of the EGR cooler.

However, for further improvement in fuel efficiency, the EGR cooler made of heavy stainless steel is strongly required to be replaced with one made of lightweight aluminum alloy, so that development is urged to make an aluminum alloy material that can meet the requirement.

As one form of the heat exchanger for automobiles made of aluminum alloy, a combination of a tube formed from a three-layer brazing sheet in a clad structure including a brazing material, a core material and a sacrificial anticorrosion layer, and an external fin formed by corrugating a single-layer external fin material, with the tube and the fin joined by brazing, is currently used.

Since the tube is used for circulating a fluid such as refrigerant, the occurrence of leak caused by pitting is a fatal wound for a heat exchanger.

Accordingly, examples of the effective anticorrosion method for suppressing the occurrence of pitting corrosion of the tube include a widely used anticorrosion method for a core material, in which an Al—Zn layer is formed on the surface of the tube by clad rolling or the like so as to achieve a sacrificial anticorrosion effect of the Al—Zn layer (e.g., Patent Literature 1 and Patent Literature 2). Further, in order to impart some sacrificial effect to the external fin, addition of Zn or like to the external fin material is performed to ensure the corrosion resistance of the tube.

### CITATION LIST

### Patent Literature

[Patent Literature 1] Japanese Patent Laid-Open No. 2014-177694
[Patent Literature 2] Japanese Patent Laid-Open No. 2014-178101

### SUMMARY OF INVENTION

### Technical Problem

In a gasoline engine provided with an EGR system, when the temperature of the three-way catalyst installed in an exhaust gas path is low, ammonia is generated during reduction of NOₓ so as to get mixed into the exhaust gas in some cases. The three-way catalyst is a catalytic device made from platinum, palladium, and rhodium, which removes harmful substances in exhaust gas in parallel by oxidizing hydrocarbons to water and carbon dioxide, oxidizing carbon monoxide to carbon dioxide, and reducing nitrogen oxides to nitrogen. Also, in a diesel engine provided with an EGR system, ammonia gets mixed into the exhaust gas in some cases due to influence of a urea SCR system which is installed for injection of urea water into an exhaust gas path to cause a chemical reaction between ammonia produced by hydrolysis and nitrogen oxides for reduction to nitrogen and water.

As a result, in the exhaust gas recirculation system of an internal combustion engine, ammonium ions are comprised in the condensed water of the exhaust gas in some cases, causing corrosion of aluminum alloy components, which has been a problem. While with an ammonium ion content of less than 100 ppm in the condensed water of the exhaust gas, the corrosion accelerating effect on the aluminum alloy components is small, with an ammonium ion content of 100 ppm or more in the condensed water of the exhaust gas, the corrosion accelerating effect on the aluminum alloy components becomes noticeable.

Accordingly, an object of the present invention is to provide an aluminum alloy heat exchanger for an exhaust gas recirculation system comprising a fin joined by brazing in a path through which an exhaust gas circulates, which has a long service life with a slow corrosion rate under an ammonium environment with ammonium comprised in the condensed water of an exhaust gas.

### Solution to Problem

The problem can be solved by the present invention described below.

That is, the present invention (1) relates to an aluminum alloy heat exchanger for an exhaust gas recirculation system, which is a heat exchanger installed in an exhaust gas recirculation system of an internal combustion engine, with an ammonium ion concentration of 100 ppm or more in the condensed water of an exhaust gas, to cool the exhaust gas, the heat exchanger obtained by brazing:

a tube material comprising at least a core material made of aluminum alloy comprising 0.01 mass % or more and 1.50 mass % or less of Si, 0.05 mass % or more and 3.00 mass % or less of Cu, and 0.40 mass % or more and 2.00 mass % or less of Mn, with the balance being Al and unavoidable impurities, and a sacrificial anticorrosion material made of aluminum alloy comprising 2.00 mass % or more and 6.00 mass % or less of Zn, with the balance being Al and unavoidable impurities, with a Si content regulated to less than 0.10 mass %, clad on the inner side surface of the core material; and a fin material comprising a core material made of aluminum alloy comprising 0.10 mass % or more and 1.50 mass % or less of Si, and 0.40 mass % or more and 2.00 mass % or less of Mn, with the balance being Al and unavoidable impurities, with a Zn content regulated to less than 0.05 mass %, and a first brazing material clad on one surface of the core material and a second brazing material clad on another surface of the core material, wherein the first brazing material made of aluminum alloy comprising 3.00 mass % or more and 13.00 mass % or less of Si, with the balance being Al and unavoidable impurities, with a Zn content regulated to less than 0.05 mass %, the second brazing material made of aluminum alloy comprising 3.00 mass % or more and 13.00 mass % or less of Si, with the balance being Al and unavoidable impurities, with a Zn content regulated to less than 0.05 mass %.

Also, the present invention (2) provides the aluminum alloy heat exchanger for an exhaust gas recirculation system according to (1), wherein the tube material comprises a brazing material comprising 3.00 mass % or more and 13.00 mass % or less of Si, with the balance being Al and unavoidable impurities, clad on a surface opposite to the surface clad with a sacrificial anticorrosion material of the tube material.

Also, the present invention (3) provides the aluminum alloy heat exchanger for an exhaust gas recirculation system according to (1) or (2), wherein the core material of the tube material further comprises one or more selected from the group consisting of 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V.

Also, the present invention (4) provides the aluminum alloy heat exchanger for an exhaust gas recirculation system according to any one of (1) to (3), wherein the sacrificial anticorrosion material of the tube material further comprises one or more selected from the group consisting of 0.05 mass % or more and 2.00 mass % or less of Mn, 0.05 mass % or more and 0.50 mass % or less of Mg, 0.05 mass % or more and 0.30 mass % or less of In, 0.05 mass % or more and 0.30 mass % or less of Sn, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V.

Also, the present invention (5) provides the aluminum alloy heat exchanger for an exhaust gas recirculation system according to any one of (1) to (4), wherein the core material of the fin material further comprises one or more selected from the group consisting of 0.05 mass % or more and 0.50 mass % or less of Mg and 0.10 mass % or more and 1.00 mass % or less of Fe.

### Advantageous Effect of Invention

According to the present invention, an aluminum alloy heat exchanger for an exhaust gas recirculation system comprising a fin joined by brazing in a path through which an exhaust gas circulates, which has a long service life with a slow corrosion rate under an ammonium environment with ammonium ion comprised in the condensed water of the exhaust gas, can be provided.

### DESCRIPTION OF EMBODIMENTS

The aluminum alloy heat exchanger for an exhaust gas recirculation system according to the present invention is an aluminum alloy heat exchanger for an exhaust gas recirculation system, which is a heat exchanger installed in an exhaust gas recirculation system of an internal combustion engine, with an ammonium ion concentration of 100 ppm or more in the condensed water of an exhaust gas, to cool the exhaust gas, the heat exchanger obtained by brazing:

a tube material comprising at least a core material made of aluminum alloy comprising 0.01 mass % or more and 1.50 mass % or less of Si, 0.05 mass % or more and 3.00 mass % or less of Cu, and 0.40 mass % or more and 2.00 mass % or less of Mn, with the balance being Al and unavoidable impurities, and a sacrificial anticorrosion material made of aluminum alloy comprising 2.00 mass % or more and 6.00 mass % or less of Zn, with the balance being Al and unavoidable impurities, with a Si content regulated to less than 0.10 mass %, clad on the inner side surface of the core material; and a fin material comprising a core material made of aluminum alloy comprising 0.10 mass % or more and 1.50 mass % or less of Si, and 0.40 mass % or more and 2.00 mass % or less of Mn, with the balance being Al and unavoidable impurities, with a Zn content regulated to less than 0.05 mass %, and a first brazing material clad on one surface of the core material and a second brazing material clad on another surface of the core material, wherein the first brazing material made of aluminum alloy comprising 3.00 mass % or more and 13.00 mass % or less of Si, with the balance being Al and unavoidable impurities, with a Zn content regulated to less than 0.05 mass %, the second brazing material made of aluminum alloy comprising 3.00 mass % or more and 13.00 mass % or less of Si, with the balance being Al and unavoidable impurities, with a Zn content regulated to less than 0.05 mass %.

The aluminum alloy heat exchanger for an exhaust gas recirculation system according to the present invention is a heat exchanger installed in an exhaust gas recirculation system of an internal combustion engine mounted on a vehicle to cool the exhaust gas of the internal combustion engine by heat exchange, wherein the exhaust gas recirculation system of an internal combustion engine having an ammonium ion concentration of 100 ppm or more in the condensed water of an exhaust gas is installed in the exhaust gas recirculation system of the internal combustion engine. The aluminum alloy heat exchanger for an exhaust gas recirculation system according to the present invention comprises a tube made of aluminum alloy, provided with a sacrificial anticorrosion material on a side along which the exhaust gas passes, and a fin made of aluminum alloy, brazed to the surface of the sacrificial anticorrosion material of the tube. In the present invention, the exhaust gas recirculation system of an internal combustion engine having an ammonium ion concentration of 100 ppm or more in the condensed water of an exhaust gas refers to “an exhaust gas recirculation system of an internal combustion engine occasionally having an ammonium ion concentration of 100 ppm or more in the condensed water of an exhaust gas during operation of the internal combustion engine”, not referring to “an exhaust gas recirculation system of an internal combustion engine always having an ammonium ion concentration of 100 ppm or more in the condensed water of an exhaust gas during operation of the internal combustion engine”. In the exhaust gas recirculation system with the aluminum alloy heat exchanger for an exhaust gas recirculation system according to the present invention installed, the ammonium concentration in the condensed water of an exhaust gas is usually several ppm or less when the temperature of the three-way catalyst installed in the exhaust gas path is high. With an ammonium ion concentration of less than 100 ppm in the condensed water of an exhaust gas, the extent of the corrosion acceleration of the aluminum alloy heat exchanger is small, so that no particular problem occurs.

The aluminum alloy heat exchanger for an exhaust gas recirculation system according to the present invention is manufactured by the steps of forming a tube material made of aluminum alloy and having a sacrificial anticorrosion material such that the sacrificial anticorrosion material is on an inner side that comes into contact with an exhaust gas, forming a fin material comprising a first brazing material clad on one surface of a core material made of aluminum alloy and a second brazing material clad on another surface of the core material into a fin shape, and then disposing the formed fin material on the surface of the sacrificial anticorrosion material of the tube material so as to be heated for brazing, so that the fin material is joined to the surface of the sacrificial anticorrosion material of the tube material by brazing.

The present inventors have found that the coexistence of Si and Zn in the aluminum alloy heat exchanger for an exhaust gas recirculation system of an internal combustion engine, the heat exchanger having a fin brazed to the inner side surface of a tube through which the exhaust gas passes, causes marked increase in corrosion under environment with an ammonium ion concentration of 100 ppm or more. The present inventors have further found that, arrangement of Si and Zn in separate components on the surface of the exhaust gas circulating path, i.e., using a Si-containing brazing material with a Zn content regulated and using a Zn-containing sacrificial anticorrosion material with a Si content regulated, enables the corrosion rate of the tube to slow, with anticorrosion properties of each of the components enhanced.

Accordingly, in the present invention, the Si content in the sacrificial anticorrosion material of the tube material to be brazed is regulated to less than 0.10 mass % and the Zn content in the core material of the fin material and the Zn content in the brazing material are regulated to less than 0.05 mass %.

The aluminum alloy heat exchanger for an exhaust gas recirculation system according to the present invention is an aluminum alloy heat exchanger obtained by brazing a tube material and a fin material.

The tube material of the aluminum alloy heat exchanger for an exhaust gas recirculation system according to the present invention comprises at least a core material made of aluminum alloy comprising 0.10 mass % or more and 1.50 mass % or less of Si, 0.05 mass % or more and 3.00 mass % or less of Cu, and 0.40 mass % or more and 2.00 mass % or less of Mn, with the balance being Al and unavoidable impurities, and a sacrificial anticorrosion material made of aluminum alloy comprising 2.00 mass % or more and 6.00 mass % or less of Zn, with the balance being Al and unavoidable impurities, with a Si content regulated to less than 0.10 mass %, clad on the inner side surface of the core material to make an exhaust gas circulating path. In other words, the tube material is a clad material including at least a sacrificial anticorrosion material clad on a core material.

The core material of the tube material is aluminum alloy comprising 0.15 mass % or more and 1.50 mass % or less of Si, 0.05 mass % or more and 3.00 mass % or less of Cu, and 0.40 mass % or more and 2.00 mass % or less of Mn, with the balance being Al and unavoidable impurities.

The Si content in the core material of the tube material is 0.10 mass % or more and 1.50 mass % or less, preferably 0.40 mass % or more and 0.80 mass % or less. With a Si content in the core material of the tube material in the range, Si is solid-dissolved in a matrix or forms an Al—Mn—Si-based intermetallic compound, so that the strength of the tube after brazing is enhanced. Further, with the addition of Si, the potential of the core material becomes noble to increase the potential difference between the core material and the sacrificial anticorrosion material, so that the corrosion resistance of the tube is enhanced. In contrast, with a Si content in the core material of the tube material below the range, the effect of the addition of Si cannot be obtained, while with a Si content exceeding the range, the corrosion resistance may decrease due to singly crystallized Si, and the lowered melting point of the alloy results in melting of the tube material during brazing.

The Cu content in the core material of the tube material is 0.05 mass % or more and 3.00 mass % or less, preferably 0.30 mass % or more and 0.80 mass % or less. With a Cu content in the core material of the tube material in the range, the potential of aluminum becomes noble, so that the sacrificial anticorrosion effect of the sacrificial anticorrosion material is enhanced. With a Cu content in the core material of the tube material below the range, the effect of the addition of Cu cannot be obtained, while with a Cu content exceeding the range, a Cu-based intermetallic compound precipitates in the core material of the tube material resulting from thermal history in manufacturing of the material and brazing heating so as to accelerate the cathode reaction, so that the corrosion rate of the sacrificial anticorrosion material increases.

The Mn content in the core material of the tube material is 0.40 mass % or more and 2.00 mass % or less, preferably 0.80 mass % or more and 1.60 mass % or less. With a Mn content of the core material of the tube material in the range, Mn crystallizes or precipitates as an Al—Mn-based intermetallic compound to enhance the strength of the tube after brazing heating. Further, the Al—Mn-based intermetallic compound incorporates Fe, so that the inhibitory effect on corrosion resistance by Fe as an unavoidable impurity can be suppressed. In contrast, with a Mn content in the core material of the tube material below the range, the effect of the addition of Mn cannot be obtained, while with a Mn content exceeding the range, a giant intermetallic compound may crystallize to inhibit the manufacturability of the tube.

The core material of the tube material may further comprise one or more selected from the group consisting of 0.05 mass % or more and 0.50 mass % or less of Mg, 0.10 mass % or more and 1.00 mass % or less of Fe, 0.05 mass % or more and 1.00 mass % or less or Ni, 0.05 mass % or more and 0.30 mass % or less of Cr, 0.05 mass % or more and 0.30 mass % or less of Zr, and 0.05 mass % or more and 0.30 mass % or less of Ti, and 0.05 mass % or more and 0.30 mass % or less of V, on an as needed basis.

When the core material of the tube material comprises Mg, the Mg content in the core material of the tube material is 0.05 mass % or more and 0.50 mass % or less, preferably 0.10 mass % or more and 0.30 mass % or less. With a Mg content in the core material of the tube material in the range, the corrosion resistance, particularly the resistance to pitting corrosion of the tube is enhanced. In contrast, with a Mg content in the core material of the tube material below the range, the effect of the addition of Mg cannot be obtained, while with a Mg content exceeding the range, brazing may be inhibited in some cases.

When the core material of the tube material comprises Fe, the Fe content in the core material of the tube material is 0.10 mass % or more and 1.00 mass % or less. With a Fe content in the core material of the tube material in the range, the corrosion is dispersed to improve the penetration life. In contrast, with a Fe content in the core material of the tube material below the range, the effect of the addition of Fe cannot be obtained, while with a Fe content exceeding the range, the corrosion rate of the tube remarkably increases.

When the core material of the tube material comprises Ni, the Ni content in the core material of the tube material is 0.05 mass % or more and 1.00 mass % or less. With a Ni content in the core material of the tube material in the range, the corrosion is dispersed to improve the penetration life. In contrast, with a Ni content in the core material of the tube material below the range, the effect of the addition of Ni cannot be obtained, while with a Ni content exceeding the range, the corrosion rate of the tube remarkably increases.

When the core material of the tube material comprises Ti, the Ti content in the core material of the tube material is 0.05 mass % or more and 0.30 mass % or less, preferably 0.10 mass % or more and 0.20 mass % or less. When the core material of the tube material comprises Zr, the Zr content in the core material of the tube material is 0.05 mass % or more and 0.30 mass % or less, preferably 0.10 mass % or more and 0.20 mass % or less. When the core material of the tube material comprises Cr, the Cr content in the core material of the tube material is 0.05 mass % or more and 0.30 mass % or less, preferably 0.10 mass % or more and 0.20 mass % or less. When the core material of the tube material comprises V, the V content in the core material of the tube material is 0.05 mass % or more and 0.30 mass % or less, preferably 0.10 mass % or more and 0.20 mass % or less. Ti, Zr, Cr and V in the core material of the tube material contribute the improvement of the corrosion resistance, particularly the resistance to pitting corrosion of the tube. Regions with a high content of Ti, Zr, Cr and V added to the core material of the tube and regions with a low content thereof are separated and alternately distributed in a laminated form along the plate thickness direction of the material. The regions with a low content are preferentially corroded in comparison with the regions with a high content, so that a layered corrosion state is obtained. As a result, a difference in the rate of corrosion along the plate thickness direction of the material partially occurs, so that the progress of the corrosion is suppressed as a whole to improve the resistance to pitting corrosion of the tube. With a Ti, Zr, Cr or V content in the core material of the tube material below the range, the effect of the addition of Ti, Zr, Cr or V cannot be obtained, while with a content exceeding the range, a coarse compound may be formed in casting so as to inhibit the manufacturability of the tube in some cases.

The sacrificial anticorrosion material of the tube material is made of aluminum alloy comprising 2.00 mass % or more and 6.00 mass % or less of Zn, with the balance being Al and unavoidable impurities, with the Si content regulated to less than 0.10 mass %, clad on the inner side surface of the core material, i.e., the side along which the exhaust gas flows.

The Zn content in the sacrificial anticorrosion material of the tube material is 2.00 mass % or more and 6.00 mass % or less, preferably 2.20 mass % or more and 3.00 mass % or less. With a Zn content in the sacrificial anticorrosion material of the tube material in the range, the pitting potential decreases to enhance the function as the sacrificial anticorrosion material. In contrast, with a Zn content in the sacrificial anticorrosion material of the tube material below the range, the effect of the addition of Zn cannot be obtained, while with a Zn content exceeding the range, cracking may occur in casting.

The Si content in the sacrificial anticorrosion material of the tube material is less than 0.10 mass %. In an ammonium environment, the coexistence of Si and Zn in the same alloy causes a remarkable cathode reaction to increase the corrosion rate. Since a Zn-containing sacrificial anticorrosion material is disposed in the tube material for improvement of the penetration life of the tube, it is required that the Si content in the sacrificial anticorrosion material of the tube material is regulated to less than 0.10 mass %. With a Si content in the sacrificial anticorrosion material of the tube material exceeding the range, the corrosion rate increases.

The sacrificial anticorrosion material of the tube material may further comprise one or more selected from the group consisting of 0.05 mass % or more and 2.00 mass % or less of Mn, 0.05 mass % or more and 0.50 mass % or less of Mg, 0.05 mass % or more and 0.30 mass % or less of In, 0.05 mass % or more and 0.30 mass % or less of Sn, 0.05 mass % or more and 0.30 mass % or less of Ti, 0.05 mass % or more and 0.30 mass % or less of V, 0.05 mass % or more and 0.30 mass % or less of Cr, and 0.05 mass % or more and 0.30 mass % or less of Zr, on an as needed basis.

When the sacrificial anticorrosion material of the tube material comprises Mn, the Mn content in the sacrificial anticorrosion material of the tube material is 0.05 mass % or more and 2.00 mass % or less, preferably 0.20 mass % or more and 1.00 mass % or less. With a Mn content in the sacrificial anticorrosion material of the tube material in the range, Mn forms an Al—Mn-based intermetallic compound to incorporate Fe, so the inhibitory effect on corrosion resistance by Fe as an unavoidable impurity can be suppressed. In contrast, with a Mn content in the sacrificial anticorrosion material of the tube material below the range, the effect of the addition of Mn cannot be obtained, while with a Mn content exceeding the range, a giant intermetallic compound may crystallize to inhibit the manufacturability of the tube.

When the sacrificial anticorrosion material of the tube material comprises Mg, the Mg content in the sacrificial anticorrosion material of the tube material is 0.05 mass % or more and 0.50 mass % or less, preferably 0.10 mass % or more and 0.30 mass % or less. With a Mg content in the sacrificial anticorrosion material of the tube material in the range, the corrosion resistance, particularly the resistance to pitting corrosion of the tube is enhanced. In contrast, with a Mg content in the sacrificial anticorrosion material of the tube material below the range, the effect of the addition of Mg cannot be obtained, while with a Mg content exceeding the range, brazing may be inhibited in some cases.

When the sacrificial anticorrosion material of the tube material comprises In, the In content in the sacrificial anticorrosion material of the tube material is 0.05 mass % or more and 0.30 mass % or less. With an In content in the sacrificial anticorrosion material of the tube material in the range, the pitting potential decreases to enhance the function as the sacrificial anticorrosion material. In contrast, with an In content in the sacrificial anticorrosion material of the tube material below the range, the effect of the addition of In cannot be obtained, while with an In content exceeding the range, the corrosion rate of the sacrificial anticorrosion material remarkably increases.

When the sacrificial anticorrosion material of the tube material comprises Sn, the Sn content in the sacrificial anticorrosion material of the tube material is 0.05 mass % or more and 0.30 mass % or less. With a Sn content in the sacrificial anticorrosion material of the tube material in the range, the pitting potential decreases to enhance the function as the sacrificial anticorrosion material. In contrast, with a Sn content in the sacrificial anticorrosion material of the tube material below the range, the effect of the addition of Sn cannot be obtained, while with a Sn content exceeding the range, the corrosion rate of the sacrificial anticorrosion material remarkably increases.

When the sacrificial anticorrosion material of the tube material comprises Ti, the Ti content in the sacrificial anticorrosion material of the tube material is 0.05 mass % or more and 0.30 mass % or less, preferably 0.10 mass % or more and 0.20 mass % or less. When the sacrificial anticorrosion material of the tube material comprises Zr, the Zr content in the sacrificial anticorrosion material of the tube material is 0.05 mass % or more and 0.30 mass % or less, preferably 0.10 mass % or more and 0.20 mass % or less. When the sacrificial anticorrosion material of the tube material comprises Cr, the Cr content in the sacrificial anticorrosion material of the tube material is 0.05 mass % or more and 0.30 mass % or less, preferably 0.10 mass % or more and 0.20 mass % or less. When the sacrificial anticorrosion material of the tube material comprises V, the V content in the sacrificial anticorrosion material of the tube material is 0.05 mass % or more and 0.30 mass % or less, preferably 0.10 mass % or more and 0.20 mass % or less. Ti, Zr, Cr and V in the sacrificial anticorrosion material of the tube material contribute the improvement of the corrosion resistance, particularly the resistance to pitting corrosion of the sacrificial anticorrosion material. Regions with a high content of Ti, Zr, Cr and V added to the aluminum alloy and regions with a low content thereof are separated and alternately distributed in a laminated form along the plate thickness direction of the material. The regions with a low content are preferentially corroded in comparison with the regions with a high content, so that a layered corrosion state is obtained. As a result, a difference in the rate of corrosion along the plate thickness direction of the material partially occurs, so that the progress of the corrosion is suppressed as a whole to improve the resistance to pitting corrosion of the sacrificial anticorrosion material. With a Ti, Zr, Cr or V content in the sacrificial anticorrosion material of the tube material below the range, the effect of the addition of Ti, Zr, Cr or V cannot be obtained, while with a content exceeding the range, a coarse compound may be formed in casting so as to inhibit the manufacturability of the tube in some cases.

The tube material may comprise a brazing material comprising 3.00 mass % or more and 13.00 mass % or less of Si, with the balance being Al and unavoidable impurities, clad on a surface opposite to the surface clad with the sacrificial anticorrosion material. In other words, the tube material may have a brazing material clad on the surface opposite to the surface clad with the sacrificial anode material of the core material. When the tube material comprises a brazing material, the Si content in the tube material is 3.00 mass % or more and 13.00 mass % or less. With a Si content in the brazing material of the tube material in the range, the function as the brazing material works. In contrast, with a Si content below the range, the effect of the addition of Si cannot be obtained, while with a Si content exceeding the range, a giant intermetallic compound may crystallize to inhibit the manufacturability of the tube.

The fin material of the aluminum alloy heat exchanger for an exhaust gas recirculation system according to the present invention is a three-layer clad material including a first brazing material clad on one surface of a core material and a second brazing material clad on another surface of the core material. The aluminum alloy heat exchanger for an exhaust gas recirculation system according to the present invention is obtained by brazing a fin material to a surface of the sacrificial anticorrosion material of a tube material, the surface being the inner surface side of the tube through which an exhaust gas circulates.

The core material of the fin material is made of aluminum alloy comprising 0.10 mass or more and 1.50 mass % or less of Si and 0.40 mass % or more and 2.00 mass % of Mn, with the balance being Al and unavoidable impurities, with a Zn content regulated to less than 0.05 mass %.

The Si content in the core material of the fin material is 0.10 mass % or more and 1.50 mass % or less, preferably 0.40 mass % or more and 0.80 mass % or less. With a Si content in the core material of the fin material in the range, Si is solid-dissolved in a matrix or forms an Al—Mn—Si-based intermetallic compound, so that the strength of a fin after brazing is enhanced. In contrast, with a Si content below the range, the effect of the addition of Si cannot be obtained, while with a Si content exceeding the range, the corrosion resistance of the sacrificial anticorrosion material of the tube may decrease due to singly crystallized Si, and the excessively lowered melting point of the alloy results in melting of the fin material during brazing.

The Mn content in the core material of the fin material is 0.40 mass % or more and 2.00 mass % or less, preferably 0.80 mass % or more and 1.60 mass % or less. With a Mn content of the core material of the fin material in the range, Mn crystallizes or precipitates as an Al—Mn-based intermetallic compound to enhance the strength of the fin after brazing heating. Further, the Al—Mn-based intermetallic compound incorporates Fe, so that the inhibitory effect on corrosion resistance by Fe as an unavoidable impurity can be suppressed. In contrast, with a Mn content in the core material of the fin material below the range, the effect of the addition of Mn cannot be obtained, while with a Mn content exceeding the range, a giant intermetallic compound may crystallize to inhibit the manufacturability of the fin.

The Zn content in the core material of the fin material is less than 0.05 mass %. In an ammonium environment, the coexistence of Si and Zn in the same alloy causes a remarkable cathode reaction to increase the corrosion rate. Since a Si-containing brazing material is disposed in the fin material for brazing to the tube material, and Si in the brazing material diffuses into the core material by brazing heating to make the core material of the fin into an Al—Si-based alloy, it is required that the Zn content in the core material of the fin material is regulated to less than 0.05 mass %. With a Zn content in the core material of the fin material exceeding the range, the corrosion rate of the fin increases.

The core material of the fin material may further comprise one or more selected from the group consisting of 0.05 mass % or more and 0.50 mass % or less of Mg and 0.10 mass % or more and 1.00 mass % or less of Fe, on an as needed basis.

When the core material of the fin material comprises Mg, the Mg content in the core material of the fin material is 0.05 mass % or more and 0.50 mass % or less, preferably 0.10 mass % or more and 0.30 mass % or less. With a Mg content in the core material of the fin material in the range, the corrosion resistance, particularly the resistance to pitting corrosion of the tube is enhanced. In contrast, with a Mg content in the core material of the fin material below the range, the effect of the addition of Mg cannot be obtained, while with a Mg content exceeding the range, brazing may be inhibited in some cases.

When the core material of the fin material comprises Fe, the Fe content in the core material of the fin material is 0.10 mass % or more and 1.00 mass % or less. With a Fe content in the core material of the fin material in the range, the corrosion is dispersed to improve the penetration life of the tube. In contrast, with a Fe content in the core material of the fin material below the range, the effect of the addition of Fe cannot be obtained, while with a Fe content exceeding the range, the corrosion rate of the fin remarkably increases.

Each of the first brazing material and the second brazing material of the fin material is made of aluminum alloy comprising 3.00 mass or more and 13.00 mass % or less of Si, with the balance being Al and unavoidable impurities, with a Zn content regulated to less than 0.05 mass %.

The Si content in each of the first brazing material and the second brazing material of the fin material is 3.00 mass % or more and 13.00 mass % or less. With a Si content in the first brazing material and the second brazing material of the fin material in the range, the function as the brazing material works. In contrast, with a Si content in the brazing material of the fin material below the range, the effect of the addition of Si cannot be obtained, while with a Si content exceeding the range, a giant intermetallic compound may crystallize to inhibit the manufacturability of the fin material.

The Zn content in the first brazing material and the second brazing material of the fin material is less than 0.05 mass %. In an ammonium environment, the coexistence of Si and Zn in the same alloy causes a remarkable cathode reaction to increase the corrosion rate of the fin. Since a Si-comprising brazing material is disposed in the fin material for brazing to the tube material, it is required that the Zn content in the core material of the fin material is regulated to less than 0.05 mass %. With a Zn content in the core material of the fin material exceeding the range, the corrosion rate of the fin increases.

The tube material and the fin material of an aluminum alloy heat exchanger for an exhaust gas recirculation system according to the present invention are a clad material. As the method for manufacturing the clad material, any conventional method is employed without particular limitation, and the following method is preferred.

In the case of a tube material, first, ingots of a sacrificial anticorrosion material and a core material having a predetermined alloy composition are prepared by semi-continuous casting. In the case of further cladding a brazing material, an ingot of the brazing material is also prepared. Both of the surfaces of the ingots are machine-finished, and the two layers of the sacrificial anticorrosion material and the core material or the three layers of the sacrificial anticorrosion material, the core material and the brazing material are overlapped. Subsequently, preheating is performed at 400 to 550° C. for 1 to 10 hours, and the plate thickness is reduced to about 5 mm by hot rolling. Further, cold rolling and final annealing at 300 to 450° C. for 1 to 10 hours are performed to obtain a clad material having a thickness of about 0.3 mm. The clad ratio of the sacrificial anticorrosion material of a tube material is preferably 3 to 25%, particularly preferably 5 to 20%. The clad ratio of the brazing material of the tube material is preferably 5 to 20%, particularly preferably 8 to 15%.

In the case of a fin material, first, ingots of a core material and a brazing material having a predetermined alloy composition are prepared by semi-continuous casting. Both of the surfaces of the ingots are machine-finished, and the three layers of brazing material/core material/brazing material are overlapped. Subsequently, preheating is performed at 400 to 550° C. for 1 to 10 hours, and the plate thickness is reduced to about 5 mm by hot rolling. Further, cold rolling and final annealing at 300 to 450° C. for 1 to 10 hours are performed to obtain a clad material having a thickness of about 0.3 mm. The clad ratio of the brazing material of a fin material is preferably 5 to 20%, particularly preferably 8 to 15%.

### (Brazing Heating Condition)

The aluminum alloy heat exchanger for an exhaust gas recirculation system according to the present invention is manufactured by combining various components including a tube material and a fin material and brazing them. At least part of the aluminum alloy heat exchanger for an exhaust gas recirculation system according to the present invention comprises a component comprising the fin material disposed on the surface of the sacrificial anticorrosion material of the tube material, which are joined to each other.

The brazing heating method and the brazing heating conditions are not particularly limited, and a brazing method using a fluoride-based non-corrosive flux in an inert gas atmosphere is preferred as the brazing method. As the brazing heating conditions, the time required for the step of heating from 400° C. to a brazing temperature for the completion of brazing solidification in the brazing operation and the step of cooling is not particularly limited, being preferably 7 to 40 minutes. Further, the time for maintaining at 580° C. or more is preferably 3 to 20 minutes.

The present invention is specifically described with reference to examples as follows. The present invention, however, is not limited to the examples described below. It is to be understood that various changes, modifications and improvements may be made in addition to the following Examples and the specific descriptions above based on the knowledge of those skilled in the art without departing from the spirit of the present invention.

### EXAMPLES

### Examples and Comparative Examples

### <Preparation of Tube Material>

Each of aluminum alloy ingots for the core material of the tube material, the sacrificial anticorrosion material and the brazing material having a composition shown in Tables 1 to 3 was cast by semi-continuous casting, which was machine-finished to be plane and subjected to homogenization treatment at 520° C. for 6 hours.

Subsequently, based on the combination shown in Table 5, the ingot for the sacrificial anticorrosion material was overlapped on one surface of the ingot for the core material. When a brazing material is clad, an ingot for the brazing material is overlapped on the opposite surface. Thereby overlapped ingots were prepared. The thickness of the sacrificial anticorrosion material and thickness of the brazing material were adjusted such that each had a clad ratio of 10%.

Subsequently, the overlapped ingots were heat treated up to 520° C. before the step of hot rolling, and immediately hot rolled to make a two-layer or three-layer clad plate having a thickness of 3.5 mm. Subsequently, the clad plate obtained was cold rolled to a thickness of 0.30 mm, and then annealed at 500° C. for 2 hours. Through the steps described above, a two-layer or three-layer tube material having a whole thickness of 0.30 mm and a clad ratio of the sacrificial anticorrosion material layer of 10% was prepared.

### <Preparation of Fin Material>

Each of aluminum alloy ingots for the brazing material and the core material for a fin material shown in Table 3 and Table 4 was cast by semi-continuous casting, which was machine-finished to be plane and subjected to homogenization treatment at 520° C. for 6 hours.

Subsequently, based on the combination shown in Table 5 or Table 6, an ingot for the brazing material was overlapped on both surfaces of an ingot for the core material to prepare an ingot. The thickness of the brazing material was adjusted such that each had a clad ratio of 10%.

Subsequently, the overlapped ingots were heat treated up to 520° C. before the step of hot rolling, and immediately hot rolled to make a three-layer clad plate having a thickness of 3.5 mm. Further, cold rolling and final annealing at 390 to 450° C. for 4 hours were performed to prepare a three-layer fin material having a thickness of about 0.1 mm.

### <Preparation of Test Sampler for Evaluation>

The fin material obtained above was slit into a width of 16 mm, corrugated, and formed into a fin shape for a heat exchanger.

Subsequently, the tube material was cut into a width of 16 mm and a length of 70 mm to prepare a test piece of tube material, and a KF-A1F-based flux (KA1F₄ or the like) powder was applied to the surface of the sacrificial anticorrosion material of the test piece of tube material.

Subsequently, the corrugated fin material was sandwiched between two test pieces of the tube material, such that the surface of the sacrificial anticorrosion was on the fin side, and brazing heating was performed at 600° C. for 3 minutes in a nitrogen atmosphere. After brazing heating, the temperature was cooled to room temperature, and a test sample for evaluation was prepared.

### (Measurement of Pitting Potential)

A tube and a fin were cut out from the test sample for evaluation, and portions other than the measurement surface were masked with epoxy resin. These were used as test materials, and as a pretreatment, the surfaces of the test materials were cleaned by immersing in a 5% NaOH aqueous solution at 60° C. for 30 seconds and in a 30% HNO₃ aqueous solution for 60 seconds. Subsequently, acetic acid was added to a 5% NaCl aqueous solution to adjust to pH 3, which was subjected to deaeration with nitrogen for 30 minutes to prepare a measurement solution. The tube or the fin was immersed in the measurement solution at 25° C., and an anodic polarization curve was measured using a potentiostat. In the polarization curve, the potential at which the current suddenly increased was defined as the pitting potential. The results are shown in Table 5 and Table 6.

### (Corrosion Resistance)

A test sample for evaluation was subjected to a cycle corrosion test including spraying for 2 hours (spray amount: 1 to 2 ml/80 cm²/h) using, as a spray liquid, an aqueous solution at pH 4.8 containing 500 ppm of ammonium, 6 ppm of hydrochloric acid, 10 ppm of sulfuric acid, 10 ppm of nitric acid, 1000 ppm of acetic acid and 1000 ppm of formic acid, drying (relative humidity: 20 to 30%) for 2 hours, and humidifying (relative humidity: 95% or more) for 2 hours. The temperature in the test chamber was set at 50° C., and the test time was set to 3000 hours. After completion of the test, the corrosion products were removed with concentrated nitric acid. The depth of the corroded pores generated on the surface of the sacrificial anticorrosion material was then measured by the focal depth method to determine a maximum one as the corrosion depth. A sample having a maximum corrosion depth of less than 100 μm was considered to be good, and a sample having a maximum corrosion depth of 100 μm or more was considered to be poor. The results are shown in Table 5 and Table 6.

TABLE 1

| | Si | Cu | Mn | Fe | Mg | Ni | Ti | V | Or | Zr | Al |
|---|---|---|---|---|---|---|---|---|---|---|---|
| A1 | 0.50 | 0.50 | 1.00 | 0.10 | 0.00 | 0.00 | 0.00 | 0.00 | 0.00 | 0.00 | bal. |
| A2 | 0.10 | 0.50 | 1.00 | 0.10 | 0.00 | 0.00 | 0.00 | 0.00 | 0.00 | 0.00 | bal. |
| A3 | 1.50 | 0.50 | 1.00 | 0.10 | 0.00 | 0.00 | 0.00 | 0.00 | 0.00 | 0.00 | bal. |
| A4 | 0.50 | 0.05 | 1.00 | 0.10 | 0.00 | 0.00 | 0.00 | 0.00 | 0.00 | 0.00 | bal. |
| A5 | 0.50 | 3.00 | 1.00 | 0.10 | 0.00 | 0.00 | 0.00 | 0.00 | 0.00 | 0.00 | bal. |
| A6 | 0.50 | 0.50 | 0.40 | 0.10 | 0.00 | 0.00 | 0.00 | 0.00 | 0.00 | 0.00 | bal. |
| A7 | 0.50 | 0.50 | 2.00 | 0.10 | 0.00 | 0.00 | 0.00 | 0.00 | 0.00 | 0.00 | bal. |
| A8 | 0.50 | 0.50 | 1.00 | 0.10 | 0.05 | 0.00 | 0.00 | 0.00 | 0.00 | 0.00 | bal. |
| A9 | 0.50 | 0.50 | 1.00 | 0.10 | 0.50 | 0.00 | 0.00 | 0.00 | 0.00 | 0.00 | bal. |
| A10 | 0.50 | 0.50 | 1.00 | 0.20 | 0.00 | 0.00 | 0.00 | 0.00 | 0.00 | 0.00 | bal. |
| A11 | 0.50 | 0.50 | 1.00 | 1.00 | 0.00 | 0.00 | 0.00 | 0.00 | 0.00 | 0.00 | bal. |
| A12 | 0.50 | 0.50 | 1.00 | 0.10 | 0.00 | 0.05 | 0.00 | 0.00 | 0.00 | 0.00 | bal. |
| A13 | 0.50 | 0.50 | 1.00 | 0.10 | 0.00 | 1.00 | 0.00 | 0.00 | 0.00 | 0.00 | bal. |
| A14 | 0.50 | 0.50 | 1.00 | 0.10 | 0.00 | 0.00 | 0.05 | 0.00 | 0.00 | 0.00 | bal. |
| A15 | 0.50 | 0.50 | 1.00 | 0.10 | 0.00 | 0.00 | 0.30 | 0.00 | 0.00 | 0.00 | bal. |
| A16 | 0.50 | 0.50 | 1.00 | 0.10 | 0.00 | 0.00 | 0.00 | 0.05 | 0.00 | 0.00 | bal. |
| A17 | 0.50 | 0.50 | 1.00 | 0.10 | 0.00 | 0.00 | 0.00 | 0.30 | 0.00 | 0.00 | bal. |
| A18 | 0.50 | 0.50 | 1.00 | 0.10 | 0.00 | 0.00 | 0.00 | 0.00 | 0.05 | 0.00 | bal. |
| A19 | 0.50 | 0.50 | 1.00 | 0.10 | 0.00 | 0.00 | 0.00 | 0.00 | 0.30 | 0.00 | bal. |
| A20 | 0.50 | 0.50 | 1.00 | 0.10 | 0.00 | 0.00 | 0.00 | 0.00 | 0.00 | 0.05 | bal. |
| A21 | 0.50 | 0.50 | 1.00 | 0.10 | 0.00 | 0.00 | 0.00 | 0.00 | 0.00 | 0.30 | bal. |
| A22 | 0.01 | 0.50 | 1.00 | 0.10 | 0.00 | 0.00 | 0.00 | 0.00 | 0.00 | 0.00 | bal. |
| A23 | 2.00 | 0.50 | 1.00 | 0.10 | 0.00 | 0.00 | 0.00 | 0.00 | 0.00 | 0.00 | bal. |
| A24 | 0.50 | 0.01 | 1.00 | 0.10 | 0.00 | 0.00 | 0.00 | 0.00 | 0.00 | 0.00 | bal. |
| A25 | 0.50 | 5.00 | 1.00 | 0.10 | 0.00 | 0.00 | 0.00 | 0.00 | 0.00 | 0.00 | bal. |
| A26 | 0.50 | 0.50 | 0.30 | 0.10 | 0.00 | 0.00 | 0.00 | 0.00 | 0.00 | 0.00 | bal. |
| A27 | 0.50 | 0.50 | 2.50 | 0.10 | 0.00 | 0.00 | 0.00 | 0.00 | 0.00 | 0.00 | bal. |

TABLE 2

| | Si | Zn | Mn | Mg | In | Sn | Ti | V | Cr | Zr | Al |
|---|---|---|---|---|---|---|---|---|---|---|---|
| B1 | 0.05 | 3.00 | 0.00 | 0.00 | 0.00 | 0.00 | 0.00 | 0.00 | 0.00 | 0.00 | bal. |
| B2 | 0.05 | 2.00 | 0.00 | 0.00 | 0.00 | 0.00 | 0.00 | 0.00 | 0.00 | 0.00 | bal. |
| B3 | 0.05 | 6.00 | 0.00 | 0.00 | 0.00 | 0.00 | 0.00 | 0.00 | 0.00 | 0.00 | bal. |
| B4 | 0.05 | 3.00 | 0.05 | 0.00 | 0.00 | 0.00 | 0.00 | 0.00 | 0.00 | 0.00 | bal. |
| B5 | 0.05 | 3.00 | 2.00 | 0.00 | 0.00 | 0.00 | 0.00 | 0.00 | 0.00 | 0.00 | bal. |
| B6 | 0.05 | 3.00 | 0.00 | 0.05 | 0.00 | 0.00 | 0.00 | 0.00 | 0.00 | 0.00 | bal. |
| B7 | 0.05 | 3.00 | 0.00 | 0.50 | 0.00 | 0.00 | 0.00 | 0.00 | 0.00 | 0.00 | bal. |
| B8 | 0.05 | 3.00 | 0.00 | 0.00 | 0.05 | 0.00 | 0.00 | 0.00 | 0.00 | 0.00 | bal. |
| B9 | 0.05 | 3.00 | 0.00 | 0.00 | 0.30 | 0.00 | 0.00 | 0.00 | 0.00 | 0.00 | bal. |
| B10 | 0.05 | 3.00 | 0.00 | 0.00 | 0.00 | 0.05 | 0.00 | 0.00 | 0.00 | 0.00 | bal. |
| B11 | 0.05 | 3.00 | 0.00 | 0.00 | 0.00 | 0.30 | 0.00 | 0.00 | 0.00 | 0.00 | bal. |
| B12 | 0.05 | 3.00 | 0.00 | 0.00 | 0.00 | 0.00 | 0.05 | 0.00 | 0.00 | 0.00 | bal. |
| B13 | 0.05 | 3.00 | 0.00 | 0.00 | 0.00 | 0.00 | 0.30 | 0.00 | 0.00 | 0.00 | bal. |
| B14 | 0.05 | 3.00 | 0.00 | 0.00 | 0.00 | 0.00 | 0.00 | 0.05 | 0.00 | 0.00 | bal. |
| B15 | 0.05 | 3.00 | 0.00 | 0.00 | 0.00 | 0.00 | 0.00 | 0.30 | 0.00 | 0.00 | bal. |
| B16 | 0.05 | 3.00 | 0.00 | 0.00 | 0.00 | 0.00 | 0.00 | 0.00 | 0.05 | 0.00 | bal. |
| B17 | 0.05 | 3.00 | 0.00 | 0.00 | 0.00 | 0.00 | 0.00 | 0.00 | 0.30 | 0.00 | bal. |
| B18 | 0.05 | 3.00 | 0.00 | 0.00 | 0.00 | 0.00 | 0.00 | 0.00 | 0.00 | 0.05 | bal. |
| B19 | 0.05 | 3.00 | 0.00 | 0.00 | 0.00 | 0.00 | 0.00 | 0.00 | 0.00 | 0.30 | bal. |
| B20 | 0.50 | 3.00 | 0.00 | 0.00 | 0.00 | 0.00 | 0.00 | 0.00 | 0.00 | 0.00 | bal. |
| B21 | 0.05 | 0.50 | 0.00 | 0.00 | 0.00 | 0.00 | 0.00 | 0.00 | 0.00 | 0.00 | bal. |
| B22 | 0.05 | 8.00 | 0.00 | 0.00 | 0.00 | 0.00 | 0.00 | 0.00 | 0.00 | 0.00 | bal. |

TABLE 3

| | Si | Zn | Al |
|---|---|---|---|
| D1 | 7.00 | 0.00 | bal. |
| D2 | 3.00 | 0.00 | bal. |
| D3 | 13.00 | 0.00 | bal. |
| D4 | 7.00 | 0.02 | bal. |
| D5 | 7.00 | 0.50 | bal. |

TABLE 4

| | Si | Mn | Zn | Fe | Mg | Al |
|---|---|---|---|---|---|---|
| C1 | 0.50 | 1.00 | 0.00 | 0.10 | 0.00 | bal. |
| C2 | 0.10 | 1.00 | 0.00 | 0.10 | 0.00 | bal. |
| C3 | 1.50 | 1.00 | 0.00 | 0.10 | 0.00 | bal. |
| C4 | 0.50 | 0.40 | 0.00 | 0.10 | 0.00 | bal. |
| C5 | 0.50 | 2.00 | 0.00 | 0.10 | 0.00 | bal. |
| C6 | 0.50 | 1.00 | 0.02 | 0.10 | 0.00 | bal. |
| C7 | 0.50 | 1.00 | 0.00 | 0.10 | 0.05 | bal. |
| C8 | 0.50 | 1.00 | 0.00 | 0.10 | 0.50 | bal. |
| C9 | 0.50 | 1.00 | 0.00 | 0.20 | 0.00 | bal. |
| C10 | 0.50 | 1.00 | 0.00 | 1.00 | 0.00 | bal. |
| C11 | 0.01 | 1.00 | 0.00 | 0.10 | 0.00 | bal. |
| C12 | 2.00 | 1.00 | 0.00 | 0.10 | 0.00 | bal. |
| C13 | 0.50 | 0.20 | 0.00 | 0.10 | 0.00 | bal. |
| C14 | 0.50 | 2.50 | 0.00 | 0.10 | 0.00 | bal. |
| C15 | 0.50 | 1.00 | 0.50 | 0.10 | 0.00 | bal. |

TABLE 5

| | Tube/Core | Tube/Sacrificial | Tube/ | Fin/Core | Fin/Brazing | Corrosion test |
|---|---|---|---|---|---|---|
| | material | material | Brazing | material | material | result/μm |
| Example 1 | A1 | B1 | — | C1 | D1 | 67 |
| Example 2 | A2 | B1 | — | C1 | D1 | 67 |
| Example 3 | A3 | B1 | — | C1 | D1 | 56 |
| Example 4 | A4 | B1 | — | C1 | D1 | 62 |
| Example 5 | A5 | B1 | — | C1 | D1 | 54 |
| Example 6 | A6 | B1 | — | C1 | D1 | 70 |
| Example 7 | A7 | B1 | — | C1 | D1 | 56 |
| Example 8 | A8 | B1 | — | C1 | D1 | 47 |
| Example 9 | A9 | B1 | — | C1 | D1 | 43 |
| Example 10 | A10 | B1 | — | C1 | D1 | 34 |
| Example 11 | A11 | B1 | — | C1 | D1 | 47 |
| Example 12 | A12 | B1 | — | C1 | D1 | 45 |
| Example 13 | A13 | B1 | — | C1 | D1 | 36 |
| Example 14 | A14 | B1 | — | C1 | D1 | 39 |
| Example 15 | A15 | B1 | — | C1 | D1 | 32 |
| Example 16 | A16 | B1 | — | C1 | D1 | 44 |
| Example 17 | A17 | B1 | — | C1 | D1 | 39 |
| Example 18 | A18 | B1 | — | C1 | D1 | 44 |
| Example 19 | A19 | B1 | — | C1 | D1 | 41 |
| Example 20 | A20 | B1 | — | C1 | D1 | 42 |
| Example 21 | A21 | B1 | — | C1 | D1 | 38 |
| Example 22 | A1 | B1 | D1 | C1 | D1 | 77 |
| Example 23 | A1 | B1 | D2 | C1 | D1 | 76 |
| Example 24 | A1 | B1 | D3 | C1 | D1 | 66 |
| Example 25 | A1 | B1 | D4 | C1 | D1 | 67 |
| Example 26 | A1 | B2 | — | C1 | D1 | 50 |
| Example 27 | A1 | B3 | — | C1 | D1 | 57 |
| Example 28 | A1 | B4 | — | C1 | D1 | 50 |
| Example 29 | A1 | B5 | — | C1 | D1 | 31 |
| Example 30 | A1 | B6 | — | C1 | D1 | 40 |
| Example 31 | A1 | B7 | — | C1 | D1 | 43 |
| Example 32 | A1 | B8 | — | C1 | D1 | 43 |
| Example 33 | A1 | B9 | — | C1 | D1 | 31 |
| Example 34 | A1 | B10 | — | C1 | D1 | 42 |
| Example 35 | A1 | B11 | — | C1 | D1 | 42 |
| Example 36 | A1 | B12 | — | C1 | D1 | 38 |
| Example 37 | A1 | B13 | — | C1 | D1 | 44 |
| Example 38 | A1 | B14 | — | C1 | D1 | 43 |
| Example 39 | A1 | B15 | — | C1 | D1 | 39 |
| Example 40 | A1 | B16 | — | C1 | D1 | 36 |
| Example 41 | A1 | B17 | — | C1 | D1 | 47 |
| Example 42 | A1 | B18 | — | C1 | D1 | 35 |
| Example 43 | A1 | B19 | — | C1 | D1 | 47 |
| Example 44 | A1 | B1 | — | C2 | D1 | 56 |
| Example 45 | A1 | B1 | — | C3 | D1 | 69 |
| Example 46 | A1 | B1 | — | C4 | D1 | 61 |
| Example 47 | A1 | B1 | — | C5 | D1 | 58 |
| Example 48 | A1 | B1 | — | C6 | D1 | 56 |
| Example 49 | A1 | B1 | — | C7 | D1 | 37 |
| Example 50 | A1 | B1 | — | C8 | D1 | 42 |
| Example 51 | A1 | B1 | — | C9 | D1 | 32 |
| Example 52 | A1 | B1 | — | C10 | D1 | 42 |
| Example 53 | A1 | B1 | — | C1 | D2 | 59 |
| Example 54 | A1 | B1 | — | C1 | D3 | 54 |
| Example 55 | A1 | B1 | — | C1 | D4 | 88 |

TABLE 6

| | Tube/Core | Tube/Sacrificial | Tube/ | Fin/Core | Fin/Brazing | Corrosion test |
|---|---|---|---|---|---|---|
| | material | material | Brazing | material | material | result/μm |
| Comparative | A22 | B1 | — | C1 | D1 | 195 |
| Example 1 | | | | | | |
| Comparative | A23 | B1 | — | C1 | D1 | — |
| Example 2 | | | | | | |
| Comparative | A24 | B1 | — | C1 | D1 | 192 |
| Example 3 | | | | | | |
| Comparative | A25 | B1 | — | C1 | D1 | — |
| Example 4 | | | | | | |
| Comparative | A26 | B1 | — | C1 | D1 | 203 |
| Example 5 | | | | | | |
| Comparative | A27 | B1 | — | C1 | D1 | — |
| Example 6 | | | | | | |
| Comparative | A1 | B20 | — | C1 | D1 | 192 |
| Example 7 | | | | | | |
| Comparative | A1 | B21 | — | C1 | D1 | 201 |
| Example 8 | | | | | | |
| Comparative | A1 | B22 | — | C1 | D1 | 178 |
| Example 9 | | | | | | |
| Comparative | A1 | B1 | — | C11 | D1 | 206 |
| Example 10 | | | | | | |
| Comparative | A1 | B1 | — | C12 | D1 | — |
| Example 11 | | | | | | |
| Comparative | A1 | B1 | — | C13 | D1 | 191 |
| Example 12 | | | | | | |
| Comparative | A1 | B1 | — | C14 | D1 | — |
| Example 13 | | | | | | |
| Comparative | A1 | B1 | — | C15 | D1 | 206 |
| Example 14 | | | | | | |
| Comparative | A1 | B1 | — | C1 | D5 | 195 |
| Example 15 | | | | | | |

In all Examples, there existed no problem with manufacturability of the tube material or the fin material, the brazing property was good, and the corrosion resistance after the cycle corrosion test was excellent.

In Comparative Examples 4, 6 and 13, melting or cracking occurred during manufacturing of the tube material or the fin material, so that the subsequent evaluations were unable to be performed.

In Comparative Examples 2 and 11, the tube or the fin was melted during brazing, so that the subsequent evaluations were unable to be performed.

In Comparative Examples 1, 3, 5, 7 to 10, 12, 14 and 15, the corrosion resistance was poor.

1. An aluminum alloy heat exchanger for an exhaust gas recirculation system, which is a heat exchanger installed in an exhaust gas recirculation system of an internal combustion engine, with an ammonium ion concentration of 100 ppm or more in condensed water of an exhaust gas, to cool the exhaust gas, the heat exchanger obtained by brazing:
a tube material comprising at least a core material made of aluminum alloy comprising 0.01 mass % or more and 1.50 mass % or less of Si, 0.05 mass % or more and 3.00 mass % or less of Cu, and 0.40 mass % or more and 2.00 mass % or less of Mn, and
optionally one or more selected from the group consisting of 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V,
with the balance being Al and unavoidable impurities, and a sacrificial anticorrosion material made of aluminum alloy comprising 2.00 mass % or more and 6.00 mass % or less of Zn, and
optionally one or more selected from the group consisting of 0.05 mass % or more and 2.00 mass % or less of Mn, 0.05 mass % or more and 0.50 mass % or less of Mg, 0.05 mass % or more and 0.30 mass % or less of In, 0.05 mass % or more and 0.30 mass % or less of Sn, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V,
with the balance being Al and unavoidable impurities, with a Si content regulated to less than 0.10 mass %, clad on an inner side surface of the core material; and
a fin material comprising a core material made of aluminum alloy comprising 0.10 mass % or more and 1.50 mass % or less of Si, and 0.40 mass % or more and 2.00 mass % or less of Mn, and
optionally one or more selected from the group consisting of 0.05 mass % or more and 0.50 mass % or less of Mg and 0.10 mass % or more and 1.00 mass % or less of Fe,
with the balance being Al and unavoidable impurities, with a Zn content regulated to less than 0.05 mass %, and a first brazing material clad on one surface of the core material and a second brazing material clad on another surface of the core material, wherein the first brazing material made of aluminum alloy comprising 3.00 mass % or more and 13.00 mass % or less of Si, with the balance being Al and unavoidable impurities, with a Zn content regulated to less than 0.05 mass %, the second brazing material made of aluminum alloy comprising 3.00 mass % or more and 13.00 mass % or less of Si, with the balance being Al and unavoidable impurities, with a Zn content regulated to less than 0.05 mass %.

2. The aluminum alloy heat exchanger for an exhaust gas recirculation system according to claim 1,
wherein the tube material comprises a brazing material comprising 3.00 mass % or more and 13.00 mass % or less of Si, with the balance being Al and unavoidable impurities, clad on a surface opposite to the surface clad with the sacrificial anticorrosion material of the tube material.

3. (canceled)

4. (canceled)

5. (canceled)
